(19) United States
(12) Patent Application Publication
(10) Pub. No.: US 2026/0155621 A1
(43) Pub. Date: Jun. 4, 2026

(54) DUAL-PATH ACOUSTO-OPTIC INTERFERENCE-BASED ULTRA-HIGH SPEED FREQUENCY DIVISION METHOD FOR LASER PULSE REPETITION FREQUENCY

(71) Applicant: FUDAN UNIVERSITY, Shanghai (CN)

(72) Inventors: Saijun WU, Shanghai (CN); Ruijuan LIU, Shanghai (CN); Yudi MA, Shanghai (CN); Lingjing JI, Shanghai (CN)

(21) Appl. No.: 18/686,085

(22) PCT Filed: Aug. 19, 2022
(86) PCT No.: PCT/CN2022/113684

§ 371 Date: Feb. 23, 2024

(30) Foreign Application Priority Data
Aug. 29, 2021 (CN) 202110999437.0

(51) Int. Cl. H01S 3/117; H01S 3/10

(52) U.S. Cl. CPC H01S 3/117; H01S 3/10053

(57) ABSTRACT

A dual-path acoustic-optic interference-based ultra-high speed frequency division method for a laser pulse repetition frequency, relating to the technical field of pulse laser regulation. The method comprises: performing precise imaging, by means of a 4-F imaging system, on AOM acoustic wave fields propagating in opposite directions, implementing fast switching of an output diffraction order by means of an interference effect of an acoustic-optic diffraction amplitude, so that a pulse sequence of a mode-locked laser is alternately sent to transmission and diffraction directions, and the optical phase of a diffraction pulse is adjusted by using an average phase of two AOMs, thereby implementing high-efficiency high-contrast phase-controllable frequency division of a high-power laser pulse having an output repetition frequency up to several GHz. Also provided is a dual-path acousto-optic interference-based ultra-high speed frequency division system for a laser pulse repetition frequency, comprising: a synchronically radio frequency signal encoding module, a dual-modulator acousto-optic modulation module, and a pulsed light waveform monitoring module. The present invention is an important expansion of a mode-locked laser high-frequency coherent modulation technique and has important application prospects.

### FIELD OF INVENTION

A dual-path acousto-optic interference-based ultra-high speed frequency division method for a laser pulse repetition frequency, relating to the technical field of pulse laser regulation.

### BACKGROUND

Ultra-fast pulse technology, based on passive mode-locking theory such as nonlinear Kerr lens effect, has greatly enhanced people's ability to study and control motion of matter with ultra-strong pulses on ultra-short time scales. The passive mode locking technique requires that an ultra-fast laser output to form a pulse train with a repetition rate of fᵣₑₚ=c/L₀. Here c is the speed of light, and L₀ is the effective length of the laser cavity. For a typical ultrafast laser, L₀ is on the scale of a meter, and fᵣₑₚ is on a scale of 100 MHz. For certain special applications, the repetition rates of the mode-locked lasers can be higher, up to GHz. To meet the requirements for the applications of pulsed lasers on different time scales, such as to implement long-time coherent control of atoms and molecules, it is desirable to divide (pre-scale) or multiply the output fᵣₑₚ to a more suitable

$${f}_{rep}^{′} ,$$

while adjusting the relative phase between the successive pulses when necessary. In the simplest example, when the pulse number j is an integer multiple of M, a pulse Aⱼ is switched to an output direction kₒᵤₜ. The repetition rate of the laser is then divided from fᵣₑₚ to

$${f}_{rep}^{′} , = {f}_{rep} / M .$$

To implement such repetition rate division, either elector-optic modulation (EOM)-based Pocketfuls cell or Bragg diffraction-based acoustic-optic modulation (AOM) devices are used. However, it is found through research that the foregoing frequency division method has at least the following disadvantages:

1. A Pockets cell based on the elector-optic modulation requires high voltage of hundreds to thousands of volts. At such high voltages, the modulation speed of Pockels cell is restricted by dissipation. It is very difficult to operate the device beyond a driving frequency of 10 MHz. Practically, with Pockels cells the modified repetition rate is limited to the order of

$${f}_{rep}^{′} \sim 1 MHz$$

or less. The moderate

$${f}_{rep}^{′}$$

in turn limits the scope of application of mode-locked lasers.

2. Inside the Pockels cell, the electric field distribution is hardly completely uniform. The nonuniform modulation affects the quality of the output beam, particularly if the laser beam has a diameter beyond 1 millimeter.

3. For the repetition rate division, the Pockels cell modulates the polarization of transmitted light, leading to modulated intensity following polarization beam splitting. The process is therefore a simple intensity modulation. Phase modulation of the transmitted light cannot be achieved at the same time. While one might add an extra EOM for the phase modulation, the accuracy of the EOM is still prone to residual electric field drifts, nonuniformity, voltage instability, etc, and it is difficult to maintain a high phase-control accuracy.

4. In acoustic-optic modulation or AOM, the low power consumption means arbitrary pulse selection may be achieved, and the carrier-envelope phase of the frequency comb can be stabilized by controlling the phases of the individual pulses. However, the high diffraction efficiency of AOM relies on the Bragg condition, which requires precise alignment of collimated incident beam. Since the Bragg angle depends on the operational frequency of AOM, f_{S}, the Bragg condition limits the operational bandwidth of AOM. In commercial AOMs, the acoustic field design is often a compromise between efficient diffraction and large operational bandwidth. The result being that neither an optimal efficiency R (80% to 90%) nor an operational bandwidth Δf_{S} (±20% around a sound wave frequency) is completely ideal.

5. The modulation bandwidth of AOM is determined by the update rate of the acoustic wave field across the laser beam. For a collimated beam, the modulation bandwidth may be written as δω_{M}=δk×vₛ, where δk is the wave-vector spread for the incident collimated beam, and v_{S} is the speed of the acoustic wave. To achieve AOM bandwidth of tens of MHz, it is usually necessary to focus the incident beam down to tens of micrometers, which further compromise the aforementioned Bragg condition. The compromise not only leads to significant decrease of the diffraction efficiency R, but may also result in output wavefront distortion. Furthermore, operating AOM with the focused laser beam reduces the optical power damage threshold of the AOM, thereby limiting the application of high-power lasers.

### SUMMARY OF INVENTION

The objective of the present invention is to provide an ultra-high-speed repetition-rate-division method for pulsed lasers, based on two-path acousto-optic interference, for efficient and phase-adjustable control of the repetition rate of the high-power mode-locked laser outputs with an initial repetition rate as high as a few GHz. The method can be iteratively applied to achieve high-contrast sub-pulse suppression, and in the output ports with reduced

$${f}_{rep}^{′}$$

to conveniently apply conventional optical manipulation and pulse shaping schemes. Our method expands the applicational perspectives of high-repetition-rate mode-locked lasers, particularly for laser cooling, atom interferometry, nonlinear quantum control and precision measurements.

In the ultra-high-speed repetition-rate division method for pulsed lasers based on two-path acousto-optic interference, according to the present invention, counter-propagating acoustic waves of AOMs are accurately imaged by a 4-F imaging system. Interference of acoustic-optical diffraction leads to rapid switching between the output diffraction orders, so that a pulse train from a mode-locked laser are alternately routed into a transmission and a diffraction direction respectively. Due to the constructive acoustic-optical interference, the modulation depth of a single AOM is substantially reduced to suppress high-order diffraction losses. As two-mode approximation becomes accurate, constructive interference by the two AOMs leads to nearly unity diffraction efficiency, which is rapidly nullified by destructive interference later. The optical phase of the nearly perfectly diffracted pulses can be controlled by adjusting the common phase of the two AOMs (see the point (7) below). The method can be implemented to realize efficient, high-contrast, and phase-controllable repetition-rate division for high-power pulsed lasers with an output repetition rate up to several GHz. Specific steps are as follows:

(1) Two acousto-optic modulators are respectively denoted as AOM₁ and AOM₂. The first modulator AOM₁ based on Bragg diffraction is used to perform single-frequency acousto-optic modulation. The modulation frequency is f_{S} For an incident mode-locked laser pulse, the output is composed by the transmitted and diffracted beams. The modulation phase for the first-order diffraction is given by φ₁(t)=2πf_{S}t+φ₁(0).

(2) The transmitted beam and the diffracted beams are accurately imaged to the center of the second modulator AOM₂ by a 4-F lens array composed of two lenses. The focal lengths of both lenses are F. The centers of acousto-optic diffractions for AOM₁ and AOM₂ are set as the object and image planes respectively.

(3) With AOM₂, the transmitted and the diffracted beams from AOM₁ is modulated again. The modulation frequency is the same f_{S} The negative-first-order diffraction has a modulation phase of φ₂(t)=−2πf_{S}t+φ₂(0). The AOM₂ output is the final output.

(4) In the foregoing process, the acoustic waves in AOM₁ and AOM₂ are in effect propagating in opposite directions through the 4-F imaging. With an initial relative phase between the modulation phase to be Δφ_{1,2}(0)≡φ₁(0)−φ₂(0), its time-dependence is given by Δφ_{1,2}(t)≡φ₁(t)−φ₂(t)=4πf_{S}t+Δφ_{1,2}(0). The high-speed phase evolution enables rapid switching between diffraction and transmission at a frequency of 2f_{S}.

(5) Diffraction efficiencies of AOM₁ and AOM₂ are respectively denoted as R₁ and R₂, The modulation depth of each single modulator in the double-AOM system is reduced to half of the modulation depth in conventional AOM applications. Therefore, high-order diffraction losses are substantially suppressed to support high diffraction efficiency unachievable by single AOM. Specifically, when R₁=R₂=0.5 and Δφ_{1,2}=π and 0, an overall transmission efficiency T̅ₘₐₓ and an overall diffraction efficiency R̅ₘₐₓ respectively reaching 100%.

(6) The initial relative phase Δφ_{1,2}(0) between AOM₁ and AOM₂ is adjusted by programming the radio-frequency signals that drive the AOMs to efficiently switch between transmission and diffraction for a radio-frequency-synchronized mode-locked pulsed laser with a repetition rate of fᵣₑₚ=4f_{S}/(2n+1) (n is an integer). The repetition-rate division f′ᵣₑₚ=fᵣₑₚ/2 is thus achieved simultaneously in the transmission and diffraction optical paths. The side-pulse rejection ratio is typically 20 dB or higher. It should be noted that this process of the repetition-rate division does not require focusing the laser. Therefore, the process can be exploited to control high-power lasers by choosing a large enough incident beam size, so that the optical intensity is below the AOM damage threshold.

(7) The common phase

$${\overline{φ}}_{1 , 2} ≡ \frac{{φ}_{1} ( t ) + {φ}_{2} ( t )}{2}$$

of AOM₁ and AOM₂, which is equal to

$$\frac{{φ}_{1} ( 0 ) + {φ}_{2} ( 0 )}{2} ,$$

is adjusted by programing the AOM radio-frequency signals, so as to accurately control the optical phase of the diffracted beam.

(8) At a cost of a small optical loss (typically at 5%-level or less), the double-AOM system operating at the f_{S} frequency can be applied again to the transmission and diffraction paths, to increase a sub-pulse rejection ratio in power to 40 dB or higher.

(9) At a cost of a small optical loss (typically at 5%-level or less), the double-AOM system operating at the

$${f}_{s}^{′}$$

can be applied to the transmission and diffraction optical paths, according to

$${f}_{rep} / 2 = 4 {f}_{s}^{′} / ( 2 {n}^{′} + 1 ) .$$

The initial fᵣₑₚ is therefore further divided into f″ᵣₑₚ=fᵣₑₚ/4. The repetition-rate-division chain can be continued to reach a MHz-level repetition rate, to be finally completely controlled by an efficient, low-bandwidth conventional single AOM.

In this invention, the two-lens 4-F system for the dual-path acousto-optic interference scheme ensures the short-time and long-term stability of the relative phase Δφ_{1,2}(0)=φ₁(0)−φ₂(0). Specifically, the diffraction and transmission optical paths share all optical elements. When an aberration-corrected lens with an appropriate short focal length F less than 10 centimeters is selected, the typical relative displacement between two optical paths does not exceed 1 millimeter. Any optical path change caused by environmental disturbance are likely within common mode noise, not to impact the coherent optical routing by the system.

In this invention, the frequency, amplitude, and phase of the radio-frequency signal for the acousto-optic modulation are digitally programmed by e.g. personal computer. One of the output beams is monitored in real time by a high-speed detector with a bandwidth greater than fᵣₑₚ. The amplitude and phase of the radio-frequency signal may be optimized in real time according to the side-pulse rejection ratio.

In this invention, based on the time-reversal symmetry, the repetition rate for two beams of properly synchronized incident pulses can be efficiently doubled at the output.

This invention further provides a systematic solution to the ultra-high-speed frequency-rate division system. As shown in FIG. 1, the system includes a phase-synchronizable radio frequency signal encoding module, a double-acousto-optic modulation (double-AOM) module, and an optical waveform monitoring module.

For the phase-synchronizable radio frequency signal encoding module, the clock signal is locked by phase locking to the repetition rate of the mode-locked laser requiring the repetition-rate division. The user may set the radio frequency signal frequency to

$${f}_{s} = \frac{( 2 n + 1 )}{4} {f}_{rep} ,$$

where n is an appropriate integer making the frequency f_{S} suitable for acousto-optic modulation. For example, if the division is to be performed on a laser with a repetition rate of fᵣₑₚ=400 MHz, then n=0 and f_{S}=100 MHz can be chosen. The amplitudes and phases of radio frequency signals 1 and 2 are then composed. After being amplified, the radio frequency signals are transmitted to drive the double-AOM module.

For the double-AOM module, the two acousto-optic modulators (AOM_{1,2}) are of the same type with shared geometrical sizes. The AOMs are imagined by a two-lens 4-F optical imaging system. Each acousto-optic modulator transduces its radio frequency signal into an acoustic wave (a crystal density modulation wave) with a corresponding frequency, intensity, and phase, thereby induces acousto-optic diffraction of the incident laser pulses. The two-lens 4-F imaging system is formed by aberration-corrected lenses l_{1,2} (typical achromatic lenses are ok). The diffracted and the transmitted beams of AOM₁ are precisely imagined with a magnifying power of M=1 to AOM₂ to form the two-path interference. Here the relative distance between the transmission and diffraction optical paths is determined by the diffraction angle of the AOM and the focal length F of the lens. Excellent relative phase stability between the two paths can be obtained by selecting a relatively short focal length F to be, for example, approximately 10 centimeters.

For the optical waveform monitoring module, it includes a high-speed light detector (with a bandwidth greater than fᵣₑₚ) and an imaging charge-coupled device (CCD) camera. The high-speed light detector monitors the interference contrast and the side-pulse rejection ratio in real time. The CCD camera monitors spatial profiles of the synchronized pulse laser outputs from the AOM system in real time.

The interference-based optical control requires excellent noise cancellation, which is achieved in this invention since all the diffracted beams share the same optical system, and therefore, relative vibration and translation drifts among optics (which are most likely to cause phase errors in optical interferometry) do not alter the optical path differences between the interfering paths. The system is therefore intrinsically stable with excellent short-term (hours to days) phase stability. The phase drifts induced by low-frequency noises can be monitored and compensated through radio-frequency programming to further enhance the long-term phase stability of the system.

The main differences between this invention and the prior art lie in the two-path acousto-optic interference effect, which breaks the limits in traditional modulation method (electro-optical or acousto-optical) in efficiency, switching speed, and operation frequency. Through accurate imaging by the 4-F system and accurate control of the amplitudes and phases of two AOMs, fast switching between diffraction orders can be implemented under a weak driving condition, so that fast, efficient, and phase-accurately-controllable repetition-rate-division is performed for high-power mode-locked pulsed lasers. As can be seen from the foregoing technical solutions, the ultra-high-speed method for repetition-rate division based on two-path acousto-optic interference has the following advantages:

(1) In contrast to typical R=80-90% efficiency by single AOM, the two-path acousto-optic interference suppress high-order diffraction loss, due to the weak driving, so that while a similar rf-control bandwidth δω_{M} is achieved, the overall diffraction efficiency R̅ₘₐₓ of the system reaches 100%.

(2) With the 4-F imaging system, acousto-optic modulator sound waves driven at frequency f_{S} becomes effectively counter-propagating. Based on high-speed evolution of a relative phase Δφ₁₂, high-speed switching between transmission and diffraction is achieved at 2f_{S} in frequency to support repetition-rate division of f′ᵣₑₚ=fᵣₑₚ/2, when fᵣₑₚ=4f_{S}/(2n+1) (n is an integer). The differences from conventional methods of repetition-rate-division based on Pockels cells or single AOMs lie in that:

(2.1) Because both the maximum transmittance T̅ₘₐₓ and maximum diffraction efficiency R̅ₘₐₓ approach 100%, while the minimum transmittance T̅ₘᵢₙ and the minimum diffraction efficiency R̅ₘᵢₙ approach zero, the repetition-rate division is simultaneously realized in the transmission and diffraction optical paths. The sub-pulse rejection ratio in terms of pulse energy is typically 20 dB or higher.

(2.2) Since both T̅ₘₐₓ and R̅ₘₐₓ approach 100%, an additional double-AOM system driven at f_{S} may be applied to either or both of the transmission and diffraction optical paths, at a cost of a very small power loss, to enhance the sub-pulse rejection ratio to 40 dB or higher.

(2.3) Since both T̅ₘₐₓ and R̅ₘₐₓ approach 100%, an additional Double-AOM system driven at f′_{S} may be applied to the transmission and diffraction optical paths, at a cost of a very small power loss. According to

$${f}_{rep} / 2 = 4 {f}_{s}^{′} / ( 2 {n}^{′} + 1 ) ,$$

the repetition-rate is divided by two again to obtain f″ᵣₑₚ=fᵣₑₚ/4. The chain of repetition-rate division may be iterated to reach an MHz-level, to be finally controlled by an efficient, low-bandwidth single AOM.

(2.4) High-speed, accurate phase adjustment to the diffracted light pulses can be achieved by programming the common phase φ̅₁₂ of the radio frequency signals. It should be noted this function can hardly be implemented in the Pockels cell solution to a same level of accuracy.

(2.5) With the double-AOM driven at f_{S}>250 MHz, the repetition-rate division can be performed for mode-locked lasers with an initial repetition rate as high as fᵣₑₚ>1 GHz. Due to the foregoing characteristic (1), the solution can be at least applied to f_{S}≈500 MHz to still keep a high efficiency, so that the repetition-rate division can be performed for lasers with a repetition rate as high as 2 GHz.

(3) Since the repetition-rate division in the present invention is based on two-path acousto-optic interference, there is no requirement for the modulation bandwidth 80M nor the necessity of focusing the laser beams. Therefore, by using large enough beam size to lower the optical intensity, the present invention can be applied to high-power lasers without damaging the AOM crystals.

(4) In the system of the present invention, since all diffraction paths share identical optical elements, the relative phase has excellent immunity to vibration noise, and the system has excellent short-term and long-term phase stability.

This invention may be used to perform efficient repetition-rate division for high-mode-locked lasers. The pulse picking efficiency of the present invention can be controlled by accurately adjusting the amplitude and phase of radio frequency signals. The present invention is a significant expansion of high-frequency modulation technology for mode-locked laser, with important applications to fields such as laser cooling, atom interferometry, nonlinear quantum control and precision measurements.

### BRIEF DESCRIPTION OF THE DRAWINGS

FIG. 1 is a schematic diagram of the ultra-high-speed repetition-rate division system for pulsed lasers based on two-path acousto-optic interference.

FIG. 2 shows time-dependent evolution of transmission efficiency and diffraction efficiency under an optimal condition (R_{1,2}≡|r_{1,2}|²≈0.5) of the double-AOM system. (a) and (b) are measurement data for a mode-locked pulse sequence (with a synchronized picosecond mode-locked laser as input), and (c) and (d) are measurement data of a time-dependent transmission and diffraction efficiencies (with a continuous-wave laser as input).

FIG. 3 shows measurement of output beam intensity for the transmission/diffraction channels when the relative phase between AOM₁ and AOM₂ is set as

$$Δ {ϕ}_{12} ( 0 ) = \frac{π}{2} ,$$

0,π (with a synchronized picosecond mode-locked laser as input).

### DETAILED DESCRIPTION

In this invention, repetition-rate division up to GHz with accurate diffraction phase control is implemented for pulsed laser with a diffraction efficiency much higher than that is achievable in conventional single AOM. In the present invention, the modulation depth of the single AOM is halved, due to the constructive two-path acousto-optic constructive interference, thereby suppressing the high-order diffraction loss., High-speed switching between transmission and diffraction with nearly ideal efficiency is achieved by constructive and destructive acousto-optic interference. Using a two-lens 4F imaging system, coherent mode matching is enforced between the diffraction paths of two AOMs with excellent phase-stability. In an initial demonstration of the method, efficiency of up to R̅ₘₐₓ=92% (T̅ₘₐₓ=93%) is obtained in the diffraction (transmission) path, while a side-pulse rejection ratio between adjacent pulses is given by R̅ₘᵢₙ=2% (T̅ₘᵢₙ=3%) respectively, thereby realizing efficient repetition-rate division for a mode-locked laser from fᵣₑₚ=80 MHz to

$${f}_{rep}^{′} = 40 MHz .$$

It is important to note that 1) By selecting a more efficient single AOM, the composite diffraction efficiency can be further enhanced to nearly 100%. And 2) If f_{S} is increased to 500 MHz, then the repetition-rate division can be performed for mode-locked laser with a very high initial repetition rate of 2 GHz. 3) If the double-AOM system is iteratively applied, the side-pulse rejection ratio can reach 30-40 dB or higher, for both the transmission and diffraction paths.

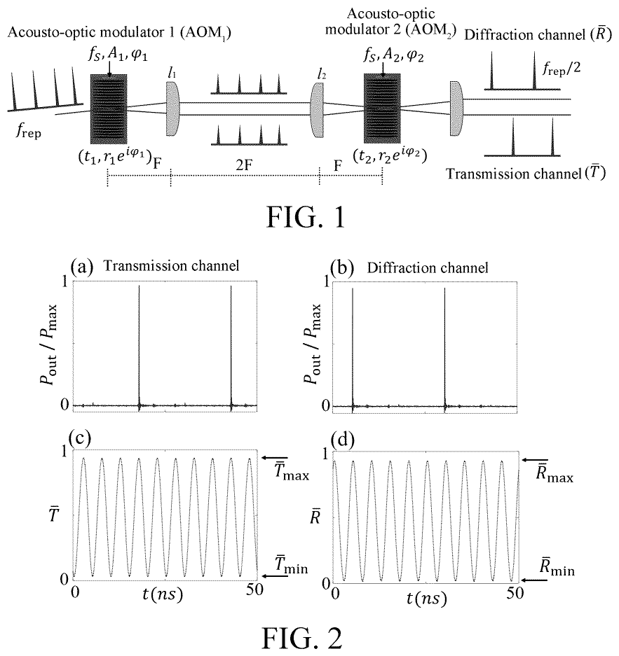

The ultra-high-speed repetition-rate division system for pulsed lasers, based on two-path acousto-optic interference, is shown in FIG. 1 with examples of experimental tests. In the experiment, the radio frequency signal to drive the acousto-optic modulator is 100 MHz, the sound speed is vₛ=4260 m/s. Continuous wave (λ=795 nm) or pulsed laser (λ=795 nm, fᵣₑₚ=80 MHz, with pulse width τ≈11 ps) enters AOM₁ under the Bragg condition. The diffracted and transmitted beams are accurately imaged to AOM₂ through a 4-F achromatic lens (F=10 cm) array for the second diffraction. The depth of single AOM modulation is halved to suppress high-order diffraction losses. As such, each AOM is described by a 2×2 matrix U=U(rᵢe^{iφ}^{ᵢ}, tᵢ), parameterized by a reflection coefficient (rᵢe^{iφ}^{ᵢ}) and a transmission coefficient (tᵢ). The {rᵢ,φᵢ} of each AOM is adjusted for efficient switching between transmission and diffraction of a synchronous mode-locked laser, so as to achieve repetition-rate division,

$${f}_{rep}^{′} = {f}_{rep} / 2 ,$$

simultaneously in the transmission and diffraction optical paths. A high-speed detector is used to measure the single-AOM diffraction efficiency |rᵢ|², the single-AOM transmission efficiency |tᵢ|², the maximum overall diffraction efficiency R̅ₘₐₓ, and the maximum overall transmission efficiency T̅ₘₐₓ of a double-AOM system. The amplitudes and phases of the double-AOM are optimized in real time according to actual measurement results. The spatial mode features of the pulsed laser output are observed by using a CCD camera for careful analysis on the double-AOM system when necessary.

(c) and (d) in FIG. 2 show the transmission and diffraction efficiencies with time, measured with a continuous-wave laser input. Here, while the single AOM can only reach a diffraction efficiency of about 80%, the maximum overall efficiency for the diffraction (transmission) channel of the double-AOM system reaches R̅ₘₐₓ≈92% (T̅ₘₐₓ≈93%) during constructive acoustic-optical interference respectively. The overall efficiencies for diffraction (transmission) reduce to R̅ₘᵢₙ≈2% (T̅ₘᵢₙ≈3%) during destructive acoustic-optical interference. Based on the foregoing measurement results, accurately controlling relative phase Δφ_{1,2}(0) through program, the mode-locked laser with a repetition rate of 80 MHz is alternately routed into the transmission and the diffraction paths, both to obtain output pulse sequences with

$${f}_{rep}^{′} = \frac{{f}_{rep}}{2} = 40$$

MHz, as shown in FIGS. 2(a) and (b). After considering a 5% insertion loss, the pulse picking efficiency of the diffraction (transmission) channel is

$$\frac{{P}_{out}}{{p}_{max}} = 92 \% ( 93 \% ) ,$$

with a side-pulse rejection ratio of up to 50:1(30:1). This simple experiment confirms that this invention has the advantage of implementing high-speed, high-contrast, and phase-adjustable coherent repetition-rate division for mode-locked laser pulses at very high repetition rate.

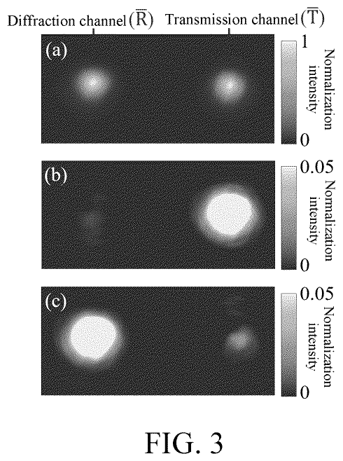

FIG. 3 shows measurement results by a CCD camera when the double-AOM system is adjusted with different relative phases

$$Δ {ϕ}_{12} = \frac{π}{2} ′ ,$$

0,π. Specifically, oy setting the driving frequency to be f_{S}=80 MHz, the double-AOM system route the mode-locked laser with the same 80 MHz rate in a stable manner, allowing direct observation of the optical profiles in the diffraction (transmission) channels with the CCD camera, without physically adjusting the beams. By adjusting the relative phase Δφ₁₂, the overall diffraction efficiency of R̅≈0.5,0,1 can be realized. When R̅≈0,1, the laser output subjected to destructive interference is very weak. The camera exposure time needs to be increased drastically from 20 μs to 5 ms before the residual beam shapes can be seen. Such residual features may be analyzed further to improve the performance of the double-AOM system.

1. In the ultra-high-speed repetition-rate division method for pulsed lasers based on two-path acousto-optic interference, according to the present invention, counter-propagating acoustic waves of AOMs are accurately imaged by a 4-F imaging system. Interference of acoustic-optical diffraction leads to rapid switching between the output diffraction orders, so that a pulse train from a mode-locked laser are alternately routed into a transmission and diffraction direction respectively. Due to the constructive acoustic-optical interference, the modulation depth of a single AOM is substantially reduced to suppress high-order diffraction losses. As two-mode approximation becomes accurate, constructive interference by the two AOMs leads to nearly unity diffraction efficiency, which is rapidly nullified by destructive interference later. The optical phase of the nearly perfectly diffracted pulses can be controlled by adjusting the common phase of the two AOMs. The method can be implemented to realize efficient, high-contrast, and phase-controllable repetition-rate division for high-power pulsed lasers with an output repetition rate up to several GHz; and specific steps are as follows:
(1) Two acousto-optic modulators are respectively denoted as AOM₁ and AOM₂. The first modulator AOM₁ based on Bragg diffraction is used to perform single-frequency acousto-optic modulation. The modulation frequency is f_{S}. For an incident mode-locked laser pulse, the output is composited by the transmitted and diffracted beams. The modulation phase for the first-order diffraction is given by φ₁(t)=2πf_{S}t+φ₁(0).
(2) The transmitted beam and the diffracted beams are accurately imaged to the center of the second modulator AOM₂ by a 4-F lens array composed of two lenses. The focal lengths of both lenses are F. The centers of acousto-optic diffractions for AOM₁ and AOM₂ are set as the object and image planes respectively.
(3) With AOM₂, the transmitted and the diffracted beams from AOM₁ is modulated again. The modulation frequency is the same f_{S}. The negative-first-order diffraction has a modulation phase of φ₂(t)=−2πf_{S}t+φ₂(0). The AOM₂ output is the final output.
(4) In the foregoing process, the acoustic waves in AOM₁ and AOM₂ are in effect propagating in opposite directions through the 4-F imaging. With an initial relative phase between the modulation phase to be Δφ_{1,2}(0)≡φ₁(0)−φ₂(0), its time-dependence is given by Δφ_{1,2}(t)≡φ₁(t)−φ₂(t)=4πf_{S}t+Δφ_{1,2}(0). The high-speed phase evolution enables rapid switching between diffraction and transmission at a frequency of 2f_{S}.
(5) Diffraction efficiencies of AOM₁ and AOM₂ are respectively denoted as R₁ and R₂, The modulation depth of each single modulator in the double-AOM system is reduced to half of the modulation depth in conventional AOM applications. Therefore, high-order diffraction losses are substantially suppressed to support exceptionally high diffraction efficiency unachievable by single AOM. Specifically, when R₁=R₂=0.5 and Δφ_{1,2}=π and 0, an overall transmission efficiency T̅ₘₐₓ and a overall diffraction efficiency R̅ₘₐₓ respectively reaching 100%; and
(6) the initial relative phase Δφ_{1,2}(0) between AOM₁ and AOM₂ is adjusted by programming the radio-frequency signals that drive the AOMs to efficiently switch between transmission and diffraction for a radio-frequency-synchronized mode-locked pulsed laser with a repetition rate of fᵣₑₚ=4f_{S}/(2n+1) (n is an integer). The repetition-rate division f′ᵣₑₚ=fᵣₑₚ/2 is thus achieved simultaneously in the transmission and diffraction optical paths; and
(7) the common phase
$${\overline{φ}}_{1 , 2} ≡ \frac{{φ}_{1} ( t ) + {φ}_{2} ( t )}{2}$$
of AOM₁ and AOM₂, which is equal to
$$\frac{{φ}_{1} ( 0 ) + {φ}_{2} ( 0 )}{2} ,$$
is adjusted by programing the AOM radio-frequency signals, so as to accurately control the optical phase of the diffracted beam.

2. The ultra-high-speed repetition-rate division method for pulsed lasers according to claim 1, wherein further, at a cost of a small optical loss (typically at 5%-level or less), the double-AOM system operating at the f_{S} frequency can be applied again to the transmission and diffraction paths, to increase a sub-pulse rejection ratio to 40 dB or higher.

3. The ultra-high-speed repetition-rate division method for pulsed lasers according to claim 1, wherein further, at a cost of a small optical loss (typically at 5%-level or less), the double-AOM system operating at the
$${f}_{s}^{′}$$
can be applied to the transmission and diffraction optical paths, according to
$${f}_{rep} / 2 = 4 {f}_{s}^{′} / ( 2 {n}^{′} + 1 ) .$$
The initial fᵣₑₚ is therefore further divided into f″ᵣₑₚ=fᵣₑₚ/4. The repetition-rate-division chain can be continued to reach a MHz-level repetition rate, to be finally completely controlled by an efficient, low-bandwidth conventional single AOM.

4. The ultra-high-speed repetition-rate division method for pulsed lasers according to claim 1, wherein the diffraction and transmission optical paths share all optical elements. When an aberration-corrected lens with an appropriate short focal length F less than 10 centimeters is selected, the typical relative displacement between two optical paths does not exceed 1 millimeter. Any optical path change caused by environmental disturbance are likely within common mode noise, not to impact the coherent optical routing by the system.

5. The ultra-high-speed repetition-rate division method for pulsed lasers according to claim 4, wherein the frequency, amplitude, and phase of the radio frequency signal to drive the acousto-optic modulation are digitally programmed, with output beams monitored in real time by high-speed light detector, and with the amplitude and phase of the radio frequency signal optimized in real time according to the rejection ratio between adjacent pulses.

6. The ultra-high-speed repetition-rate division method for pulsed lasers according to claim 1, comprising: a phase-synchronize radio frequency signal encoding module, a double-acousto-optic modulation (double-AOM) module, and an optical waveform monitoring module, wherein
For the phase-synchronize radio frequency signal encoding module, the clock signal is locked by phase locking to the repetition rate of the mode-locked laser requiring the repetition-rate division. The user may set the radio frequency signal frequency to
$${f}_{S} = \frac{( 2 n + 1 )}{4} {f}_{rep} ,$$
where n is an appropriate integer making the frequency f_{S} suitable for acousto-optic modulation. For example, if the division is to be performed on a laser with a repetition rate of fᵣₑₚ=400 MHz, then n=0 and f_{S}=100 MHz can be chosen. The amplitudes and phases of radio frequency signals 1 and 2 are then composed. After being amplified, the radio frequency signals are transmitted to drive the double-AOM module.
For the double-AOM module, the two acousto-optic modulators (AOM_{1,2}) are of the same type with shared geometrical sizes. The AOMs are imagined by a two-lens 4-F optical imaging system. Each acousto-optic modulator transduces its radio frequency signal into an acoustic wave (a crystal density modulation wave) with a corresponding frequency, intensity, and phase, thereby induces acousto-optic diffraction of the incident laser pulses. The two-lens 4-F imaging system is formed by aberration-corrected (typical achromatic lenses are ok) lenses l_{1,2}. The diffracted and the transmitted beams of AOM₁ are precisely imagined with a magnifying power of M=1 to AOM₂ to form the two-path interference. Here the relative distance between the transmission and diffraction optical paths is determined by the diffraction angle of the AOM and the focal length F of the lens. Excellent relative phase stability between the two paths can be obtained by selecting a relatively short focal length F to be, for example, approximately 10 centimeters.
For the optical waveform monitoring module, it includes a high-speed light detector (with a bandwidth greater than fᵣₑₚ) and an imaging charge-coupled device (CCD) camera. The high-speed light detector monitors the interference contrast and the side-pulse rejection ratio in real time. The CCD camera monitors spatial profiles of the synchronized pulse laser outputs from the AOM system in real time.

7. The ultra-high-speed repetition-rate division method for pulsed lasers according to claim 6, wherein all the diffracted beams share the same optical system, and therefore, relative vibration and translation drifts among optics (which are most likely to cause phase errors in optical interferometry) do not alter the optical path differences between the interfering paths. The system is therefore intrinsically stable with excellent short-term (hours to days) phase stability. The phase drifts induced by low-frequency noises can be monitored and compensated through radio-frequency programming to further enhance the long-term phase stability of the system.
